(19) United States
(12) Patent Application Publication
(10) Pub. No.: US 2024/0403822 A1
(43) Pub. Date: Dec. 5, 2024

(54) PRODUCT MANAGEMENT APPARATUS, PRODUCT MANAGEMENT METHOD, AND NON-TRANSITORY COMPUTER-READABLE MEDIUM

(71) Applicant: NEC Corporation, Minato-ku, Tokyo (JP)

(72) Inventor: Jun UCHIMURA, Tokyo (JP)

(73) Assignee: NEC Corporation, Minato-ku, Tokyo (JP)

(21) Appl. No.: 18/697,205

(22) PCT Filed: Oct. 12, 2021
(86) PCT No.: PCT/JP2021/037704

§ 371 Date: Mar. 29, 2024

(51) Int. Cl. G06Q 10/087; G06K 7/10; G06Q 20/20

(52) U.S. Cl. CPC G06Q 10/087; G06K 7/10297; G06Q 20/203

(57) ABSTRACT

A showcase (40) for displaying a plurality of products is installed, and a mobile IC tag reader (30) is disposed in a store. A first IC tag (42) is attached to the showcase (40), and a second IC tag (52) is attached to a product (50). A product management apparatus (20) acquires first data read from the first IC tag (42) by the IC tag reader (30), first timing information indicating a reading timing of the first data, second data read from the second IC tag (52) by the IC tag reader (30), and second timing information indicating a reading timing of the second data. Then, the product management apparatus (20) generates position information indicating a position of the product (50) in which the showcase (40) is set as a reference, by using these pieces of information.

### TECHNICAL FIELD

The present invention relates to a product management apparatus, a product management method, and a program.

### BACKGROUND ART

A plurality of products are displayed in a store. It is important to manage a display position of these plurality of products.

For example, Patent Document 1 describes the following technique. First, a product RFID tag is attached to a product, and a position RFID tag is attached to a shelf. Then, when a salesperson stands in front of the shelf, the salesperson directs an antenna of a tag reader toward the position RFID tag or the product RFID tag, and reads data from these tags. Then, a position determination apparatus determines which position RFID tag is located at the same position as the detected product RFID, by using these pieces of data.

Further, Patent Document 2 discloses a system that registers a position of an article. Specifically, a wireless tag is attached to an article, and a fixed wireless tag is attached to a floor. Then, mobile equipment detects these wireless tags, and a position of the article is registered by using a detection result of the tags. At this occasion, the mobile equipment adjusts strength of a radio wave to be transmitted to the wireless tag in order to accurately detect a position of the wireless tag.

### RELATED DOCUMENT

### Patent Document

Patent Document 1: Japanese Patent Application Publication No. 2021-043215
Patent Document 2: Japanese Patent Application Publication No. 2007-078360

### SUMMARY OF INVENTION

### Technical Problem

In order for a salesperson or a customer to recognize a position of a product in a store, a positional relationship between the product and a showcase is important. Meanwhile, in the method described in Patent Document 1, a salesperson is required to perform work for reading an RFID tag. Therefore, a burden on the salesperson increases.

One example of an object of the present invention is to reduce a burden on a salesperson when recognizing a positional relationship between a product and a showcase.

### Solution to Problem

One aspect of the present invention provides a product management apparatus that manages positions of a plurality of products in a store, in which,
in the store, a showcase for displaying the plurality of products is installed, and a mobile IC tag reader is disposed,
a plurality of first IC tags are attached to the showcase or a floor of the store in a state of being away from one another, and a second IC tag is attached to each of the plurality of products, and
the IC tag reader tries to repeatedly read the first IC tag and the second IC tag while moving within the store,
the product management apparatus including:
   an acquisition unit that acquires first data read from the first IC tag by the IC tag reader, first timing information indicating a reading timing of the first data, second data read from the second IC tag by the IC tag reader, and second timing information indicating a reading timing of the second data; and
   an information processing unit that generates position information indicating positions of the plurality of products in which a plurality of the showcases are set as a reference, by using the first data, the first timing information, the second data, and the second timing information.

The present invention provides a product management method to be performed by a computer that manages positions of a plurality of products in a store, in which,
in the store, a showcase for displaying the plurality of products is installed, and a mobile IC tag reader is disposed, and
a plurality of first IC tags are attached to the showcase or a floor of the store in a state of being away from one another, and a second IC tag is attached to each of the plurality of products,
the product management method including,
by the computer executing:
   acquisition processing of acquiring first data read from the first IC tag by the IC tag reader, first timing information indicating a reading timing of the first data, second data read from the second IC tag by the IC tag reader, and second timing information indicating a reading timing of the second data; and
   information processing of generating position information indicating positions of the plurality of products in which a plurality of the showcases are set as a reference, by using the first data, the first timing information, the second data, and the second timing information.

The present invention provides a program executable by a computer that manages positions of a plurality of products in a store, in which,
in the store, a showcase for displaying the plurality of products is installed, and a mobile IC tag reader is disposed, and
a plurality of first IC tags are attached to the showcase or a floor of the store in a state of being away from one another, and a second IC tag is attached to each of the plurality of products,
the program causing the computer to include:
   an acquisition function of acquiring first data read from the first IC tag by the IC tag reader, first timing information indicating a reading timing of the first data, second data read from the second IC tag by the IC tag reader, and second timing information indicating a reading timing of the second data: and
   an information processing function of generating position information indicating positions of the plurality of products in which a plurality of the showcases are set as a reference, by using the first data, the first timing information, the second data, and the second timing information.

### Advantageous Effects of Invention

One aspect of the present invention allows a burden on a salesperson at the time when recognizing a positional relationship between a product and a showcase to be small.

### BRIEF DESCRIPTION OF DRAWINGS

The above-described object, the other objects, features, and advantages will become more apparent from a suitable example embodiment described below and the following accompanying drawings.

FIG. 1 It is a diagram for describing a usage environment of a product management system according to an example embodiment.

FIG. 2 It is a diagram illustrating one example of information stored in a tag information storage unit.

FIG. 3 It is a diagram illustrating one example of a functional configuration of a product management apparatus.

FIG. 4 It is a diagram illustrating a first example of information stored in a position information storage unit.

FIG. 5 It is a diagram illustrating a second example of information stored in the position information storage unit.

FIG. 6 It is a diagram for describing a first example of a position information generation method.

FIG. 7 It is a diagram for describing a second example of the position information generation method.

FIG. 8 It is a diagram illustrating a modification example of FIG. 5.

FIG. 9 It is a diagram illustrating a modification example of FIG. 6.

FIG. 10 It is a diagram illustrating a hardware configuration example of the product management apparatus.

FIG. 11 It is a flowchart illustrating one example of processing to be performed by the product management apparatus.

### DESCRIPTION OF EMBODIMENTS

Hereinafter, an example embodiment according to the present invention is described by using the drawings. Note that, in all drawings, a similar constituent element is indicated by a similar reference sign, and description thereof will not be repeated as appropriate.

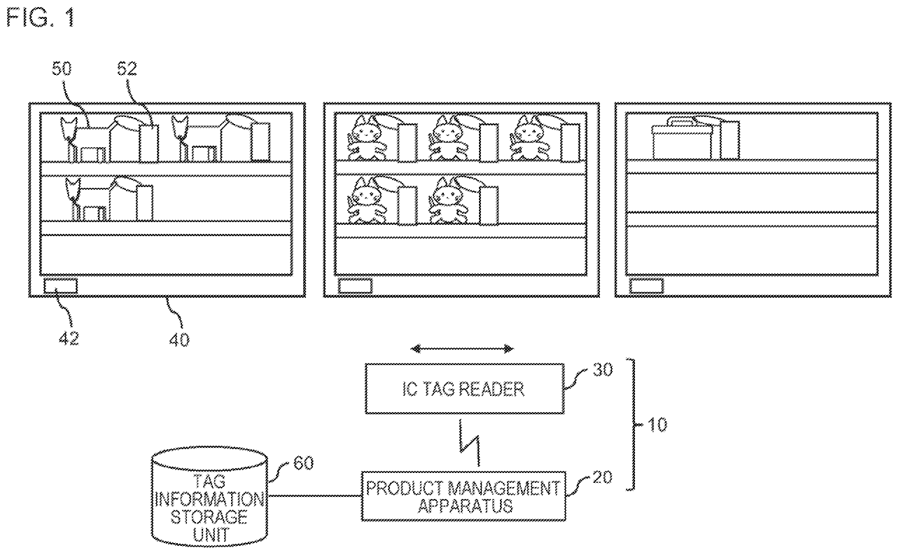

FIG. 1 is a diagram for describing a usage environment of a product management system 10 according to an example embodiment. The product management system 10 is a system that manages a position of a product in a store, and includes a product management apparatus 20 and a mobile IC tag reader 30.

A plurality of showcases 40, for example, product shelves are installed in a store. A plurality of products 50 are displayed in these plurality of showcases 40. A first IC tag 42 is attached to the showcase 40, and a second IC tag 52 is attached to the product 50. Herein, at least one first IC tag 42 is attached to one showcase 40. For example, when a showcase 40 is large, a first IC tag 42 may be attached to each of portions of the one showcase 40 away from each other.

The IC tag reader 30 tries to repeatedly read the first IC tag 42 and the second IC tag 52 at any time while moving within a store, and while being stationary within a store. For example, the IC tag reader 30 tries to communicate with the first IC tag 42 and the second IC tag 52 at least once in one second.

The IC tag reader 30 is carried by, for example, a salesperson. Then, when a salesperson is moving within a store to perform another piece of work or the like, the IC tag reader 30 communicates with the first IC tag 42 and the second IC tag 52. However, the IC tag reader 30 may be attached to an object, for example, a basket or a cart moving together with a customer in a store.

Hereinafter, information read from the first IC tag 42 by the IC tag reader 30 is described as first data, and information read from the second IC tag 52 by the IC tag reader 30 is described as second data. First data include at least tag identification information of the first IC tag 42, and second data include at least tag identification information of the second IC tag 52. Further, information indicating a timing at which the IC tag reader 30 reads first data is described as first timing information, and information indicating a timing at which the IC tag reader 30 reads second data is described as second timing information.

The product management apparatus 20 generates position information of each of a plurality of products 50 in which each of a plurality of showcases 40 is set as a reference, by using a reading result by the IC tag reader 30. The position information indicates a position of the product 50 when any of the showcases 40 is set as a reference. At this occasion, the product management apparatus 20 uses first timing information and second timing information.

Note that, the first IC tag 42 may not be attached to the showcase 40, but may be fixed to a floor of a store. In this case, a plurality of the first IC tags 42 are fixed to the floor in a state of being away from one another.

Further, the product management apparatus 20 can utilize a tag information storage unit 60. The tag information storage unit 60 stores second tag identification information in association with detail information of a product to which the second IC tag 52 associated with the second tag identification information is attached. Therefore, the product management apparatus 20 can acquire detail information of the product to which the second IC tag 52 is attached, by using the tag information storage unit 60.

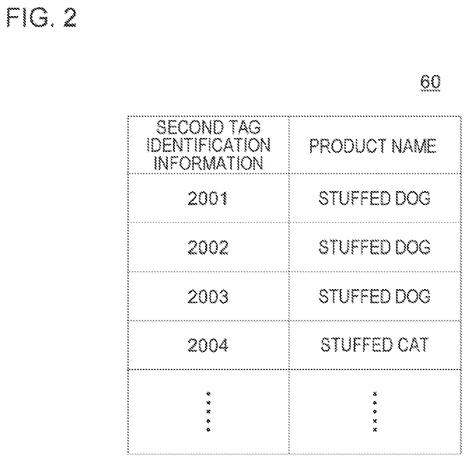

FIG. 2 is a diagram illustrating one example of information stored in the tag information storage unit 60. As described above, the tag information storage unit 60 stores second tag identification information in association with detail information of a product to which the second IC tag 52 associated with the second tag identification information is attached. Detail information of a product includes at least a product name.

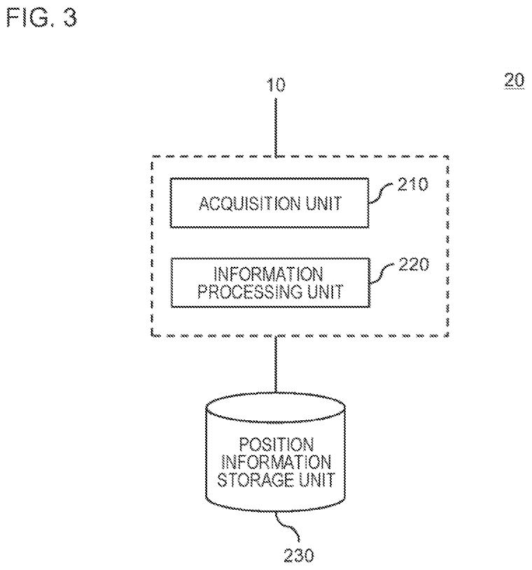

FIG. 3 is a diagram illustrating one example of a functional configuration of the product management apparatus 20. The product management apparatus 20 includes an acquisition unit 210 and an information processing unit 220.

The acquisition unit 210 acquires, from the IC tag reader 30, first data and first timing information, and second data and second timing information.

The information processing unit 220 generates position information by using first data and first timing information, and second data and second timing information. As described above, the position information indicates a position of each product 50 in which any of the showcases 40 is set as a reference. For example, the position information indicates a showcase 40 closest to a product 50 for each of a plurality of the products 50. Note that, a specific example of a position information generation method is described later by using another drawing.

The information processing unit 220 causes a position information storage unit 230 to store generated position information. Therefore, a salesperson or a customer can recognize a showcase 40 in which a desired product 50 is presumed to be displayed by searching the position information storage unit 230.

Note that, the information processing unit 220 causes the position information storage unit 230 to further store first data and first timing information, and second data and second timing information.

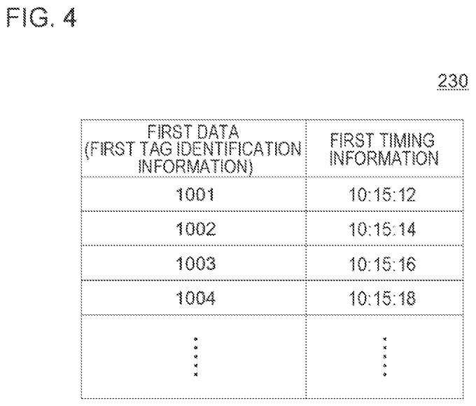

FIG. 4 is a diagram illustrating a first example of information stored in the position information storage unit 230. As illustrated in FIG. 4, the position information storage unit 230 stores first data, and first timing information associated with the first data in association with each other. In FIG. 4, tag identification information of the first IC tag 42 is described as first tag identification information.

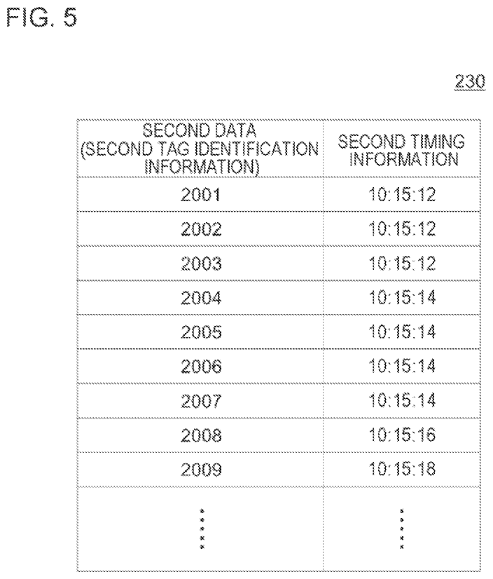

FIG. 5 is a diagram illustrating a second example of information stored in the position information storage unit 230. As illustrated in FIG. 5, the position information storage unit 230 stores second data, and second timing information associated with the second data in association with each other. In FIG. 5, tag identification information of the second IC tag 52 is described as second tag identification information. Since a plurality of products 50 are displayed in one showcase 40, the IC tag reader 30 communicates with a plurality of second IC tags 52 at the same timing. Therefore, it is often a case that one piece of second timing information is associated with a plurality of pieces of second tag identification information in the position information storage unit 230.

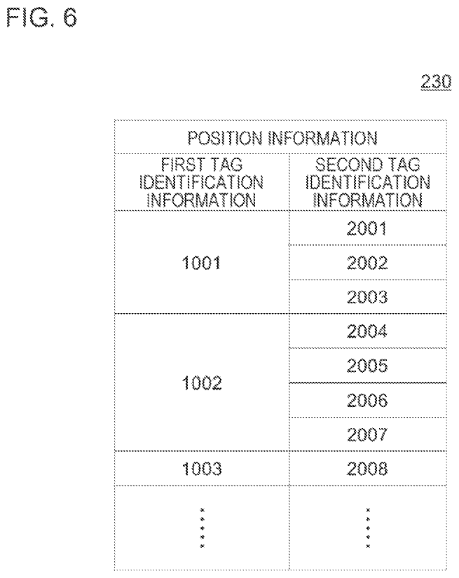

FIG. 6 is a diagram for describing a first example of the position information generation method. It is assumed that the IC tag reader 30 tries to communicate with the first IC tag 42 and the second IC tag 52 at a certain timing. Then, it can be presumed that the first IC tag 42 and the second IC tag 52 with which the IC tag reader 30 communicates at the timing are located close to each other. In view of the above, the information processing unit 220 of the product management apparatus 20 selects second timing information indicating the same timing as first timing information for each piece of the first timing information, and combines the second data associated with the selected second timing information with the first data associated with the first timing information. Then, the information processing unit 220 generates position information by using the combination. In the example illustrated in FIG. 6, the information processing unit 220 sets the combination, as the position information.

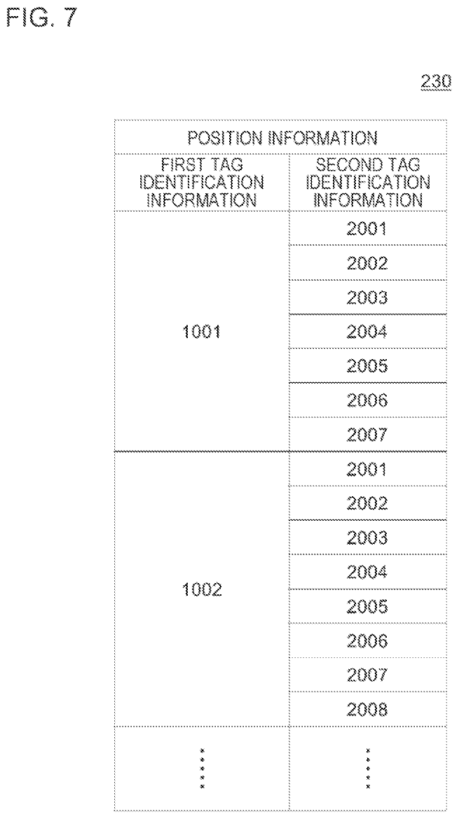

FIG. 7 is a diagram for describing a second example of the position information generation method. In the example illustrated in FIG. 7, the information processing unit 220 selects second timing information in which a difference with respect to first timing information is equal to or less than a reference for each piece of the first timing information, and combines the second data associated with the selected second timing information with the first data associated with the first timing information. For example, the information processing unit 220 selects second timing information indicating the same timing as the first timing information, second timing information immediately previous to the first timing information, and second timing information immediately previous to the first timing information.

Then, the information processing unit 220 generates position information by using the combination. In the example illustrated in FIG. 7, the information processing unit 220 sets the combination, as the position information.

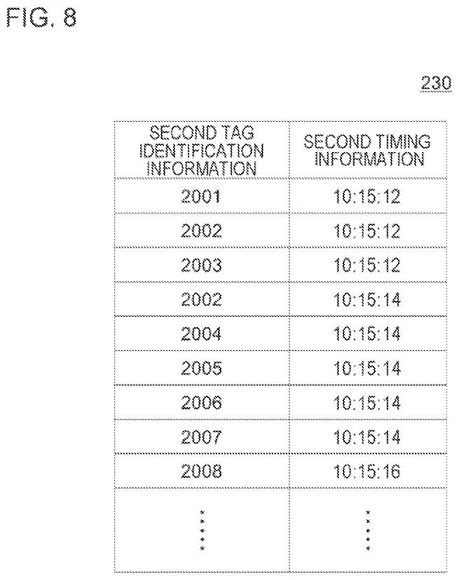

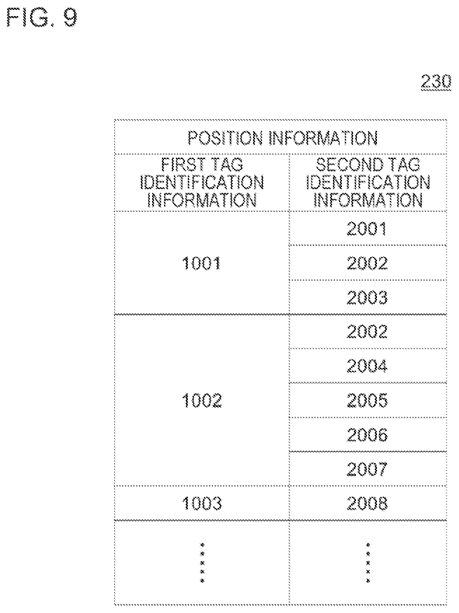

FIG. 8 is a diagram illustrating a modification example of FIG. 5. As illustrated by second tag identification information “2002” in FIG. 8, the IC tag reader 30 may read second tag identification information from the same second IC tag 52 at timings different from each other. In this case, as illustrated in FIG. 9, the information processing unit 220 may associate one piece of second tag identification information with a plurality of pieces of first tag identification information. In this case, a salesperson or a customer can presume that a product 50 associated with the second tag identification information is located near a boundary of a plurality of showcases 40 associated with the plurality of pieces of first tag identification information.

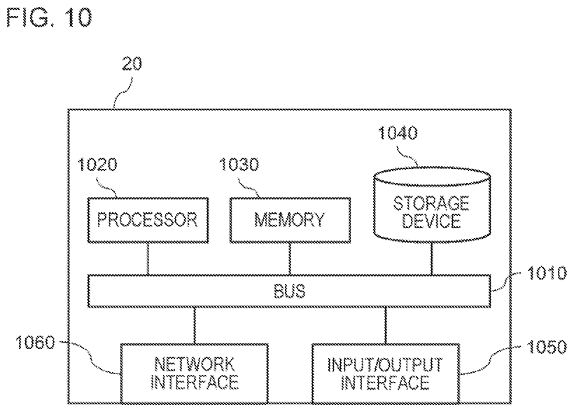

FIG. 10 is a diagram illustrating a hardware configuration example of the product management apparatus 20. The product management apparatus 20 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a removable medium such as a memory card, a read only memory (ROM), or the like. The storage device 1040 stores a program module that achieves each function (e.g., the acquisition unit 210 and the information processing unit 220) of the product management apparatus 20. Each function associated with each program module is achieved by causing the processor 1020 to read the program module in the memory 1030 and execute the program module. Further, the storage device 1040 also functions as the position information storage unit 230.

The input/output interface 1050 is an interface for connecting the product management apparatus 20 to various pieces of input/output equipment.

The network interface 1060 is an interface for connecting the product management apparatus 20 to a network. The network is, for example, a local area network (LAN) or a wide area network (WAN). A method of connecting the network interface 1060 to the network may be wireless connection, or may be wired connection. The product management apparatus 20 may communicate with the IC tag reader 30 via the network interface 1060.

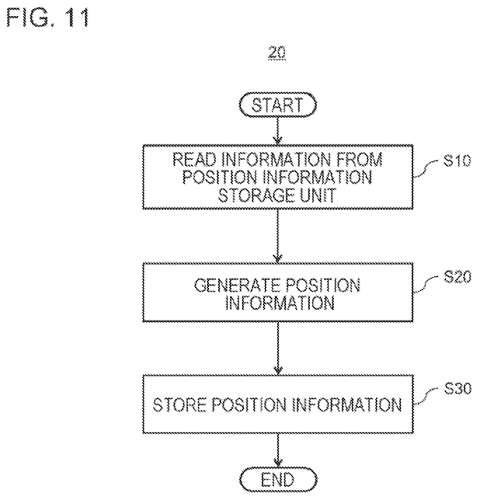

FIG. 11 is a flowchart illustrating one example of processing to be performed by the product management apparatus 20. The IC tag reader 30 tries to repeatedly communicate with the first IC tag 42 and the second IC tag 52 independently of the processing illustrated in FIG. 11. Then, the acquisition unit 210 of the product management apparatus 20 repeatedly acquires, from the IC tag reader 30, first information and first timing information, and second information and second timing information, and stores the acquired pieces of information in the position information storage unit 230.

Then, the information processing unit 220 of the product management apparatus 20 performs processing illustrated in FIG. 11 at a predetermined timing. First, the information processing unit 220 acquires, from the position information storage unit 230, first information and first timing information, and second information and second timing information (step S10). Then, the position information storage unit 230 generates position information by using these pieces of read information (step S20), and causes the position information storage unit 230 to store the generated position information (step S30).

Then, a salesperson or a customer inputs, to the product management apparatus 20, information on a product of which a position is desired to confirm, for example, a product name. Then, the information processing unit 220 of the product management apparatus 20 reads, from the tag information storage unit 60, second tag identification information associated with the information, and reads, from the position information storage unit 230, position information associated with the read second tag identification information. Then, the information processing unit 220 causes, for example, a display or a terminal to display the read position information.

As described above, according to the present example embodiment, the IC tag reader 30 tries to repeatedly communicate with the first IC tag 42 and the second IC tag 52 while moving within a store. Movement of the IC tag reader 30 is performed concurrently with, for example, movement of a salesperson carrying the IC tag reader 30 for performing another piece of work, or movement of a customer. Then, the acquisition unit 210 of the product management apparatus 20 acquires, from the IC tag reader 30, first information and first timing information, and second information and second timing information. Then, the information processing unit 220 generates position information by using these pieces of information, and causes the position information storage unit 230 to store the generated position information. Therefore, a burden on a salesperson is small when recognizing a position of the product 50 in which the showcase 40 is set as a reference.

As described above, while the example embodiment according to the present invention has been described with reference to the drawings, these are an example of the present invention, and various configurations other than the above can also be adopted.

Further, in a plurality of flowcharts used in the above description, a plurality of steps (pieces of processing) are described in order. However, an order of execution of steps to be performed in each example embodiment is not limited to the order of description. In each example embodiment, the illustrated order of steps can be changed within a range that does not adversely affect a content. Further, the above-described example embodiments can be combined, as far as contents do not conflict with each other.

A part or all of the above-described example embodiments may also be described as the following supplementary notes, but are not limited to the following.
1. A product management apparatus that manages positions of a plurality of products in a store, in which,
   in the store, a showcase for displaying the plurality of products is installed, and a mobile IC tag reader is disposed,
   a plurality of first IC tags are attached to the showcase or a floor of the store in a state of being away from one another, and a second IC tag is attached to each of the plurality of products, and
   the IC tag reader tries to repeatedly read the first IC tag and the second IC tag while moving within the store,
   the product management apparatus including:
      an acquisition unit that acquires first data read from the first IC tag by the IC tag reader, first timing information indicating a reading timing of the first data, second data read from the second IC tag by the IC tag reader, and second timing information indicating a reading timing of the second data; and
      an information processing unit that generates position information indicating positions of the plurality of products in which a plurality of the showcases are set as a reference, by using the first data, the first timing information, the second data, and the second timing information.
2. The product management apparatus according to supplementary note 1, in which
   the information processing unit, for each piece of the first timing information,
      selects the second timing information in which a difference with respect to the first timing information is equal to or less than a reference,
      combines the second data associated with the selected second timing information with the first data associated with the first timing information, and
      generates the position information by using the combination.
3. The product management apparatus according to supplementary note 1, in which
the information processing unit, for each piece of the first timing information,
   selects the second timing information indicating a same timing as the first timing information,
   combines the second data associated with the selected second timing information with the first data associated with the first timing information, and
   generates the position information by using the combination.
4. A product management method to be performed by a computer that manages positions of a plurality of products in a store, in which,
   in the store, a showcase for displaying the plurality of products is installed, and a mobile IC tag reader is disposed, and
   a plurality of first IC tags are attached to the showcase or a floor of the store in a state of being away from one another, and a second IC tag is attached to each of the plurality of products,
   the product management method including,
   by the computer executing:
      acquisition processing of acquiring first data read from the first IC tag by the IC tag reader, first timing information indicating a reading timing of the first data, second data read from the second IC tag by the IC tag reader, and second timing information indicating a reading timing of the second data; and
      information processing of generating position information indicating positions of the plurality of products in which a plurality of the showcases are set as a reference, by using the first data, the first timing information, the second data, and the second timing information.
5. The product management method according to supplementary note 4, in which,
   by the computer, in the information processing, for each piece of the first timing information:
      the second timing information in which a difference with respect to the first timing information is equal to or less than a reference is selected:
      the second data associated with the selected second timing information is combined with the first data associated with the first timing information; and
      the position information is generated by using the combination.
6. The product management method according to supplementary note 4, in which,
   by the computer, in the information processing, for each piece of the first timing information:
      the second timing information indicating a same timing as the first timing information is selected:
      the second data associated with the selected second timing information is combined with the first data associated with the first timing information; and
      the position information is generated by using the combination.
7. A program executable by a computer that manages positions of a plurality of products in a store, in which,
   in the store, a showcase for displaying the plurality of products is installed, and a mobile IC tag reader is disposed, and
   a plurality of first IC tags are attached to the showcase or a floor of the store in a state of being away from one another, and a second IC tag is attached to each of the plurality of products,
   the program causing the computer to include:
      an acquisition function of acquiring first data read from the first IC tag by the IC tag reader, first timing information indicating a reading timing of the first data, second data read from the second IC tag by the IC tag reader, and second timing information indicating a reading timing of the second data; and
      an information processing function of generating position information indicating positions of the plurality of products in which a plurality of the showcases are set as a reference, by using the first data, the first timing information, the second data, and the second timing information.
8. The program according to supplementary note 7, in which
   the information processing function, for each piece of the first timing information,
      selects the second timing information in which a difference with respect to the first timing information is equal to or less than a reference,
      combines the second data associated with the selected second timing information with the first data associated with the first timing information, and
      generates the position information by using the combination.
9. The program according to supplementary note 7, in which
   the information processing function, for each piece of the first timing information,
      selects the second timing information indicating a same timing as the first timing information,
      combines the second data associated with the selected second timing information, with the first data associated with the first timing information, and
      generates the position information by using the combination.

### REFERENCE SIGNS LIST

10 Product management system
20 Product management apparatus
30 IC tag reader
40 Showcase
42 First IC tag
50 Product
52 Second IC tag
60 Tag information storage unit
210 Acquisition unit
220 Information processing unit
230 Position information storage unit

What is claimed is:

1. A product management apparatus that manages positions of a plurality of products in a store, wherein,
in the store, a showcase for displaying the plurality of products is installed, and a mobile IC tag reader is disposed,
a plurality of first IC tags are attached to the showcase or a floor of the store in a state of being away from one another, and a second IC tag is attached to each of the plurality of products, and
the IC tag reader tries to repeatedly read the first IC tag and the second IC tag while moving within the store,
the product management apparatus comprising:
at least one memory configured to store instructions; and
at least one processor configured to execute the instructions to perform operations comprising:
acquiring first data read from the first IC tag by the IC tag reader, first timing information indicating a reading timing of the first data, second data read from the second IC tag by the IC tag reader, and second timing information indicating a reading timing of the second data; and
generating position information indicating positions of the plurality of products in which a plurality of the showcases are set as a reference, by using the first data, the first timing information, the second data, and the second timing information.

2. The product management apparatus according to claim 1, wherein
the operations further comprise, for each piece of the first timing information,
selecting the second timing information in which a difference with respect to the first timing information is equal to or less than a reference,
combining the second data associated with the selected second timing information with the first data associated with the first timing information, and
generating the position information by using the combination.

3. The product management apparatus according to claim 1, wherein
the operations further comprise, for each piece of the first timing information,
selecting the second timing information indicating a same timing as the first timing information,
combining the second data associated with the selected second timing information with the first data associated with the first timing information, and
generating the position information by using the combination.

4. A product management method to be performed by a computer that manages positions of a plurality of products in a store, wherein,
in the store, a showcase for displaying the plurality of products is installed, and a mobile IC tag reader is disposed, and
a plurality of first IC tags are attached to the showcase or a floor of the store in a state of being away from one another, and a second IC tag is attached to each of the plurality of products,
the product management method comprising,
by the computer executing:
acquisition processing of acquiring first data read from the first IC tag by the IC tag reader, first timing information indicating a reading timing of the first data, second data read from the second IC tag by the IC tag reader, and second timing information indicating a reading timing of the second data; and
information processing of generating position information indicating positions of the plurality of products in which a plurality of the showcases are set as a reference, by using the first data, the first timing information, the second data, and the second timing information.

5. The product management method according to claim 4, wherein,
by the computer, in the information processing, for each piece of the first timing information:
the second timing information in which a difference with respect to the first timing information is equal to or less than a reference is selected;
the second data associated with the selected second timing information is combined with the first data associated with the first timing information; and
the position information is generated by using the combination.

6. The product management method according to claim 4, wherein,
by the computer, in the information processing, for each piece of the first timing information:
the second timing information indicating a same timing as the first timing information is selected;
the second data associated with the selected second timing information is combined with the first data associated with the first timing information; and
the position information is generated by using the combination.

7. A non-transitory computer-readable medium storing a program executable by a computer that manages positions of a plurality of products in a store, wherein,
in the store, a showcase for displaying the plurality of products is installed, and a mobile IC tag reader is disposed, and
a plurality of first IC tags are attached to the showcase or a floor of the store in a state of being away from one another, and a second IC tag is attached to each of the plurality of products,
the program causing the computer to perform operations comprising:
acquiring first data read from the first IC tag by the IC tag reader, first timing information indicating a reading timing of the first data, second data read from the second IC tag by the IC tag reader, and second timing information indicating a reading timing of the second data; and
generating position information indicating positions of the plurality of products in which a plurality of the showcases are set as a reference, by using the first data, the first timing information, the second data, and the second timing information.

8. The non-transitory computer-readable medium according to claim 7, wherein
the operations further comprise, for each piece of the first timing information,
selecting the second timing information in which a difference with respect to the first timing information is equal to or less than a reference,
combining the second data associated with the selected second timing information with the first data, associated with the first timing information, and
generating the position information by using the combination.

9. The non-transitory computer-readable medium according to claim 7, wherein
the operations further comprise, for each piece of the first timing information,
selecting the second timing information indicating a same timing as the first timing information,
combining the second data associated with the selected second timing information, with the first data associated with the first timing information, and
generating the position information by using the combination.
